(19) United States
(12) Patent Application Publication
(10) Pub. No.: US 2025/0284573 A1
(43) Pub. Date: Sep. 11, 2025

(54) MULTITHREADED ARCHITECTURE FOR ENRICHMENT PROCESSING OF TELEMETRY

(71) Applicant: Senseon Tech LTD, London (GB)

(72) Inventor: James Sebastian Emile Mistry, London (GB)

(21) Appl. No.: 19/218,092

(22) Filed: May 23, 2025

Related U.S. Application Data
(63) Continuation of application No. PCT/EP2023/082667, filed on Nov. 22, 2023.

(30) Foreign Application Priority Data
Nov. 23, 2022 (GB) 2217499.9

(51) Int. Cl. G06F 9/54; G06F 9/451; H04L 9/40; H04L 43/12; H04L 47/125; H04L 47/625; H04L 61/00; H04L 61/4511

(52) U.S. Cl. CPC G06F 9/544; H04L 43/12; H04L 47/125; H04L 47/627; H04L 61/35; H04L 61/4511; H04L 63/1416; G06F 9/451

(57) ABSTRACT

Enriched telemetry data is generated via multithreaded enrichment processing. A first processing thread extracts from a first telemetry message a piece of enrichment data and a first network address pair, and selects a storage bucket in shared memory using the first network address pair. The first thread temporarily locks the storage bucket to store the piece of enrichment data. A second processing thread extracts from a second telemetry message a matching network address pair, identifies the storage bucket using the the second network address pair, determines whether the bucket is locked, and if not, retrieves the piece of enrichment data from the storage.

### TECHNICAL FIELD

The present disclosure pertains to a multithreaded processing architecture for generating enriched telemetry for use in a downstream analysis.

### BACKGROUND

Cyber defense refers to technologies that are designed to protect computer systems from the threat of cyberattacks. In an active attack, an attacker attempts to alter or gain control of system resources. In a passive attack, an attacker only attempts to extract information from a system (generally whilst trying to evade detection). Private computer networks, such as those used for communication within businesses, are a common target for cyberattacks. An attacker who is able to breach (i.e. gain illegitimate access to) a private network may for example be able to gain access to sensitive data secured within it, and cause significant disruption if they are able to take control of resources as a consequence of the breach. A cyberattack can take various forms. A “syntactic” attack makes use of malicious software, such as viruses, worms and Trojan horses. A piece of malicious software, when executed by a device within the network, may be able to spread throughout the network, resulting in a potentially severe security breach. Other forms of “semantic” attack include, for example, denial-of-service (DOS) attacks which attempt to disrupt network services by targeting large volumes of data at a network; attacks via the unauthorized use of credentials (e.g. brute force or dictionary attacks); or backdoor attacks in which an attacker attempts to bypass network security systems altogether. With increasing emphasis on “remote” access, though remote desktop or virtual private network (VPN) connections and the like, further vulnerabilities and attack opportunities are created.

Various forms of telemetry may support a cybersecurity analysis. Telemetry may be collected in the form of telemetry messages, and it may be useful to enrich at least some of the telemetry messages with additional information to support a more comprehensive cybersecurity analysis. Processing large volumes of telemetry data poses various challenges, particularly if the enriched telemetry is needed to support time-critical detection and therefore needs to be performed at speed.

### SUMMARY

The present invention provides a multithreaded enrichment processing architecture, in which multiple threads operate to both extract enrichment data from incoming telemetry messages and enrich other telemetry messages with such extracted telemetry data. Load balancing across threads is performed in a way that does not guarantee that a first telemetry message containing a piece of enrichment data to be extracted will be assigned to the same thread as a second telemetry message to be enriched with that piece of enrichment data. To accommodate a situation in which the first and second telemetry messages are assigned to different threads, shared memory resources are used to share extracted enrichment data between threads. Thread synchronization is achieved using locks on the shared resources.

In this context, lock contention occurs when two threads require access to the same shared resource at the same time. The probability of lock contention occurring is reduced through the use of multiple shared and independently lockable storage buckets, together with a mapping function applied to network address pairs to achieve a reasonably uniform distribution of enrichment data across the multiple storage buckets. The architecture is particularly well suited to tailored enrichment data that is specific to an individual communication context between two communicating endpoints.

A first aspect herein is directed to computer system for generating enriched telemetry data, the computer system comprising: multiple processing threads; a shared memory accessible to each processing thread of the multiple processing threads, and embodying a plurality of storage buckets, each storage bucket lockable by any processing thread to temporarily restrict access by any other processing thread; and a load balancer configured to receive incoming telemetry messages, and allocate the incoming telemetry messages amongst the multiple processing threads, wherein the multiple processing threads are configured to perform concurrent processing of the incoming telemetry messages, including: at a first processing thread: extracting from a first telemetry message a piece of enrichment data and a first network address pair associated therewith, selecting a storage bucket of the multiple storage buckets using a predetermined mapping function applied to the first network address pair, locking the storage bucket to prevent access by any other processing thread, storing the piece of enrichment data in the storage bucket in association with the first network address pair, and unlocking the storage bucket to enable access by any other processing thread; and at a second processing thread: extracting from a second telemetry message a second network address pair that matches the first network address pair, identifying said storage bucket using the predetermined mapping function applied to the second network address pair, determining whether the storage bucket is currently locked, and (i) if so, halting processing of the second telemetry message, and (ii) if not, locking the storage bucket, retrieving the piece of enrichment data from the storage bucket by matching the second network address pair with the first network address pair, unlocking the storage bucket, and generating based on the second telemetry message an enriched telemetry message containing the piece of enrichment data.

In embodiments, the first telemetry message may be or may pertain to a response generated by a lookup server, and may comprise: a first network address of a first endpoint, a query parameter submitted by the first endpoint, and a second network address of a second endpoint, as returned by the lookup server based on the query parameter. The first network address pair may comprise the first network address and the second network address, and the piece of enrichment data extracted from the first telemetry message may comprise the query parameter.

For example, the the query response may be a domain name system (DNS) response, the first network address may be a destination internet protocol (IP) address of the DNS response, and the second network address and the query parameter may be contained in a body of the query response, the query parameter being a domain name and the second network address being a second IP address associated with the domain name.

The second telemetry message may be or may pertain to an exchanged message between the first endpoint and the second endpoint, and the second address pair may comprise a source address (e.g. course IP address) of the exchanged message and a destination address (e.g. destination IP address) of the exchanged message.

The concurrent processing may further comprise receiving a third telemetry message, extracting a third network address pair from the third telemetry message, and identifying a different storage bucket not containing said piece of enrichment data using the predetermined mapping function applied to the third network address pair. The third network address pair may have (and only have) a single address component in common with the first network address pair associated with the piece of enrichment data.

The computer system may comprise a detector configured to receive the enriched telemetry message, detect a potential cybersecurity threat using the enrichment data contained in the enriched telemetry message, and generate a cybersecurity alert responsive to detecting the potential cybersecurity threat.

For example, the cybersecurity alert may be displayed at a user interface associated with the computer system. Alternatively or additionally, the system may comprise a remediation component configured to receive the cybersecurity alert, and perform a cybersecurity remediation action in response.

The first network address pair may comprise a client network address and a server network address. The piece of enrichment data may pertain to the server network address, and the predetermined mapping function may use at least the client network address of the network address pair to select the storage bucket.

The predetermined mapping function may use both the client network address and the server network address to select the storage bucket.

If it is determined that the storage bucket is currently unlocked, the second thread may pause processing of the second telemetry message at the second processing thread until the storage bucket is unlocked.

Different forms of lock may be used, so as to not restrict read access unnecessarily. For example, the first processing thread may determine whether any other processing thread currently possesses a read lock or a write lock on the storage bucket, and if not, obtain a write lock on the storage bucket to prevent any other thread from obtaining a read lock or a write lock on the storage bucket. The second processing thread may determine whether any other processing thread currently possesses a write lock on the storage bucket and, if not, obtains a read lock which prevents any other processing thread from obtaining a write lock on the storage bucket but not from obtaining a further read lock on the storage bucket.

Each storage bucket may have allocated thereto a predetermined amount of memory.

The computer system may further comprise a network monitoring component (e.g. network TAP) configured to collect network traffic and provide a stream of telemetry messages in the form of network packets to the load balancer, the first and second telemetry messages being first and second network packets in this case.

The enriched telemetry message may contain the enrichment data and a piece of network metadata extracted from the second network packet.

A second aspect provides a method of generating enriched telemetry data in a multithreaded processor, the method comprising: receiving, at a load balancer, incoming telemetry messages; allocating the incoming telemetry messages amongst multiple processing threads, the multiple processing each having access to a shared memory embodying a plurality of storage buckets, each storage bucket lockable by any processing thread to temporarily restrict access by any other processing thread; and performing, by the the multiple processing threads, concurrent processing of the incoming telemetry messages, including: at a first processing thread: extracting from a first telemetry message a piece of enrichment data and a first network address pair associated therewith, selecting a storage bucket of the multiple storage buckets using a predetermined mapping function applied to the first network address pair, locking the storage bucket to prevent access by any other processing thread, storing the piece of enrichment data in the storage bucket in association with the first network address pair, and unlocking the storage bucket to enable access by any other processing thread, and at a second processing thread: extracting from a second telemetry message a second network address pair that matches the first network address pair, identifying said storage bucket using the predetermined mapping function applied to the second network address pair, determining whether the storage bucket is currently locked, and (i) if so, halting processing of the second telemetry message, and (ii) if not, locking the storage bucket, retrieving the piece of enrichment data from the storage bucket by matching the second network address pair with the first network address pair, unlocking the storage bucket, and generating based on the second telemetry message an enriched telemetry message containing the piece of enrichment data.

In embodiments of the second aspect, any functionality described in relation to the first aspect may be carried out.

A third aspect provides a transitory or non-transitory medium embodying computer-readable instructions, which are configured upon execution by a processor to implement the method of the second aspect or any embodiment thereof.

### BRIEF DESCRIPTION OF FIGURES

For a better understanding of the present subject matter, and to show how embodiments of the same may be carried into effect, reference is made by way of example only to the following figures in which:

FIG. 1 shows, by way of context, a schematic function block diagram of a cyber defense platform;

FIG. 2 shows an example layout of a case user interface;

FIG. 3 shows a schematic block diagram of a network which may be subject to a cyber-security analysis;

FIG. 3A shows a network monitoring system;

FIG. 4 shows a schematic block diagram of a multithreaded enrichment processing architecture;

FIG. 5 shows a schematic function block diagram of an individual processing thread;

FIG. 6A shows an example enrichment data extraction scenarios; and

FIG. 6B shows an example message enrichment scenario.

### DETAILED DESCRIPTION

A range of data may be used in a cybersecurity context as a basis for detecting cybersecurity threats (or potential threats) to any form of computerized infrastructure (such as a computer network, device, system, program or set of programs, database(s) etc.). Collected data (including metadata) indicative of such threats (or potential threats), alone or in combination with other data, may be referred to herein as “telemetry”. An example cyber defense platform is described herein that collects multiple modalities (forms) of telemetry from multiple sources and uses those various telemetry modalities as a basis for threat detection.

Enrichment is an important aspect of telemetry processing. For example, incoming telemetry messages, such as ‘raw’ network packets, may be received from one or multiple telemetry sources, and those messages may be enriched with additional information that may be relevant in a subsequent threat detection/analysis stage. For example, an incoming network telemetry message containing an internet protocol (IP) address might be augmented with additional information, identifying the IP address as belonging to a server and providing a domain name associated with the server, and/or other known details of the server (such as protocol/version information etc.). More generally, a telemetry message pertaining to a network connection (or other network flow, such as a UDP communication context) may be enriched with details about one (or both) of the endpoints not contained in the original telemetry message. As another example, a telemetry message pertaining to a particular transport address (IP address, port number) might be enriched with details about a related process (or processes) or user account on the corresponding endpoint, or some other form of endpoint data.

The described embodiments provide a multi-threaded enrichment processing architecture, in which incoming telemetry messages are received at a load balancer, and distributed amongst multiple processing threads. One source of enrichment data is the telemetry messages themselves, whereby information is extracted from certain telemetry messages, and used to enrich other telemetry messages. For example, a first telemetry message might comprise or relate to a domain name system (DNS) response that was returned by a DNS server in response to a DNS query, and which maps a server IP address to a DNS query parameter (e.g. a domain name or other DNS-related information) provided in the DNS query. When that same server IP address is observed in a second telemetry message(s), e.g. comprising or relating to a TCP packet exchanged with the server, that other telemetry message can be enriched with the DNS-related information extracted from the query.

Details of the multithreaded enrichment processing architecture are described below. First, an example context is described, in which the multithreaded processing architecture may be usefully deployed.

### Example Context

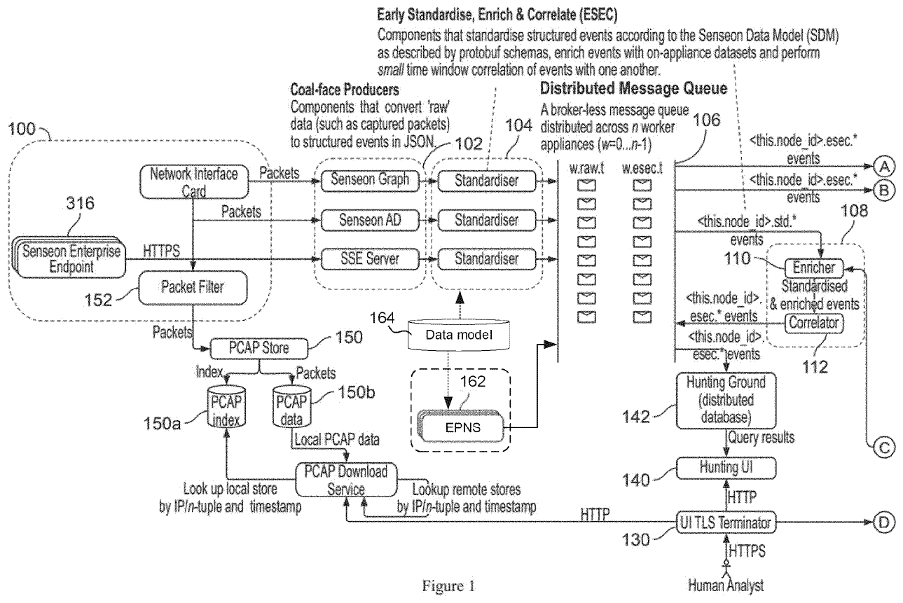

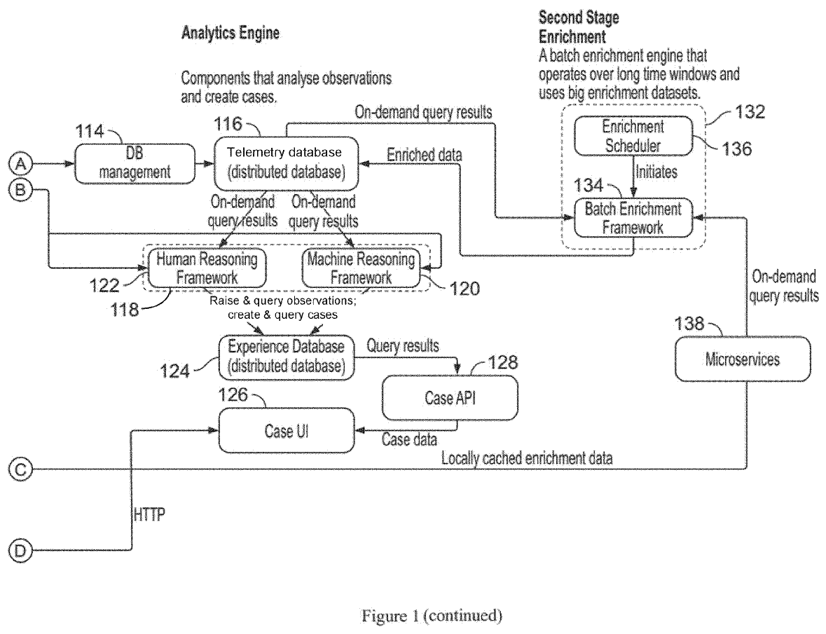

FIG. 1 shows an example of an integrated cyber defense platform, which protects a network or other computer infrastructure against cyberattacks through a combination of comprehensive telemetry collection and organization, and advanced analytics applied to the resulting output within a reasoning framework. The cyber defense platform is implemented as a set of computer programs that perform the data processing stages disclosed herein. The computer programs are executed on one or more processors of a data processing system, such as CPUs, GPUs etc.

In a data optimization stage, telemetry is captured in the form of structured telemetry events (structured messages). Various forms of telemetry may be collected, such as one or more of network telemetry, endpoint telemetry, third-party telemetry (detection/analysis results from external ‘third-party’ systems, received as inputs to the platform), cloud telemetry (pertaining to cloud computing infrastructure) etc. may be collected in telemetry events at this stage and enhanced for subsequent analysis. Events generated across different data collectors are standardized, as needed, according to a predefined telemetry data model 164, which is a telemetry serialization schema or set of telemetry serialization schemas that formally and precisely describe message structures used in the system. The telemetry data model 164 defined a set of message types and, for each message type, a set of data fields associated with the message type. Telemetry messages are generated, and their data fields are populated, in accordance with the telemetry data model 164.

Note, the term ‘message’ may be used to refer to both structured and unstructured (raw) telemetry. One example of a raw telemetry message is a network packet collected by a network TAP or mirror (such messages, of course, have a well-defined structure; the term ‘unstructured’ simply implies the data has not yet been structured in the specific form used within the platform, as defined by the data model 164). The following examples consider enrichment (and restructuring) of raw network packets at an appliance. However, the techniques may be applied to other forms of telemetry message in other implementations (e.g. to perform enrichment of telemetry messages that have already been structured or partially structured). For example, a telemetry message to be enriched might be a telemetry record summarizing a network packet(s) or other items(s) of telemetry.

The system is shown to comprise a plurality of data collectors 102 which are also referred to herein as “coal-face producers”. The role of these components 102 is to collect telemetry and, where necessary, process that data into a form suitable for downstream cyber security analysis. This may include the collection of raw network data from components of a network being monitored and conversion of that raw data into structured events (network events). The raw network data may be collected, e.g., using network TAPs or mirrors.

Event standardization components 104 are also shown, each of which receives raw telemetry data outputted from a respective one of the coal-face producers 102. The standardization components 104 standardize these structured events according to the predefined telemetry data model 164, to create standardized telemetry events.

The raw network data that is collected by the coal-face producers 102 is collected from a variety of different network components 100. The raw network data can for example include captured data packets as transmitted and received between components of the network, as well as externally incoming and outgoing packets arriving at and leaving the network respectively.

Endpoint telemetry is collected using endpoint agents 316 executed on endpoints throughout the network. This may be received at the platform and structured in a similar manner to raw network data, as depicted in FIG. 1. Alternatively, endpoint data may be structured by the endpoint agent itself according to the data model 164, in which case that data arrives at the platform in an already structured form.

An endpoint agent may be additionally (or alternatively) responsible for monitoring local network traffic. An endpoint agent with network monitoring and reporting capability may be referred to herein as an endpoint network sensor or ‘EPNS’, denoted by reference sign 162 in FIG. 1. An EPNS 162 monitors local network traffic to and from an endpoint device on which it is executed, in order to collect network data locally at the endpoint device. Local network traffic monitoring by an EPNS reduces the reliance on network TAPs and other centralized network monitoring components (but does not necessarily eliminate it all together). One option would be for the EPNS 162 to collect and send copies of all incoming/outgoing network packets for server-side processing, in the manner of a TAP or mirror (but sending a full copy of only its ‘raw’ local network traffic). In this case, the local network traffic copy would be sent to the coal face producers 102 and/or standardizers 104 of FIG. 1 for pre-processing into structured events (in the same way as raw network traffic received from dedicated monitoring components). However, to reduce transmission overhead, some or all of the functions of the coals face producers 102/standardizers 104 may be performed locally by the EPNS 162 instead. In such cases, as depicted in FIG. 1, the EPNS 162 instead transmits a more concise summary of its local traffic, in the form of network traffic metadata that has been structured by the EPNS 162 according to the data model 164 prior to transmission. The term ‘network data’ is used broadly, unless otherwise indicated, and does not necessarily imply ‘raw’ network data (in the context of EPNS reporting, network data can take the form of more-concise network metadata summarizing local network traffic). EPNS telemetry arrives at the platform in structured form, having been already structured by the EPNS 162 at the endpoint on which it is executed according to the data model 164.

Whether standardized in the backend or at the endpoints themselves, standardized telemetry events (messages) are stored in a message queue 106. For a large-scale system, the message queue 106 can be implemented as a distributed message queue distributed across multiple worker appliances.

As part of the data optimization, first stage enrichment and joining is performed. This can, to some extent at least, be performed in real-time or near-real time (processing time of around 1 second or less). That is, network and endpoint events are also enriched with additional relevant data where appropriate (enrichment data) and selectively joined (or otherwise linked together) based on short-term temporal correlations. Augmentation and joining are examples of what is referred to herein as event enhancement.

An event optimization system 108 is shown having an input for receiving telemetry events from the message queue 106, which it processes in real-time or near real-time to provide enhanced events in the manner described below. In FIG. 1, enhanced events are denoted w.esec.t, as distinct from non-enhance events denoted w.raw.t.

The event enhancement system 108 is shown to comprise an enrichment component 110 and a joining component 112. The enrichment component 106 operates to augment events from the message queue 106 with enrichment data, in a first stage enrichment. The enrichment data is data that is relevant to the event and has potential significance in a cybersecurity context. It could for example flag a file name or IP address contained in the event that is known to be malicious from a security dataset. The enrichment data can be obtained from a variety of enrichment data sources including earlier events and external information. The enrichment data used to enrich an event is stored within the event, which in turn is subsequently returned to the message queue 106 as described below. In this first-stage enrichment, the enrichment data that is obtained is limited to data that it is practical to obtain in (near) real-time. Additional batch enrichment is performed later, without this limitation, as described below.

The joining component 112 operates to identify short-term, i.e. small time window, correlations between events. This makes use of the timestamps in the events and also other data such as information about entities (devices, processes, users etc.) to which the events relate. The joining component 112 joins together events that it identifies as correlated with each other (i.e. interrelated) on the timescale considered and the resulting joined user events are returned to the message queue 106. This can include joining together one or more network events with one or more endpoint events where appropriate (applicable to network and endpoint data that has not been linked prior to reporting).

In FIG. 1, the joining component 112 is shown having an output to receive enriched events from the enrichment component 110 such that it operates to join events, as appropriate, after enrichment. This means that the joining component 112 is able to use any relevant enrichment data in the enriched events for the purposes of identifying short-term correlations. However, it will be appreciated that in some contexts at least it may be possible to perform enrichment and correlation in any order or in parallel.

A telemetry database manager 114 is shown having an input connected to receive events from the message queue 106. The telemetry database manager 114 retrieves telemetry events, and in particular enhanced (i.e. enriched and, where appropriate, joined) events from the message queue 106 and stores them in a telemetry database 116. The telemetry database 116 may be a distributed database. The telemetry database 116 stores events on a longer time scale than events are stored in the message queue 106.

A batch enrichment engine 132 performs additional (second stage) enrichment of the events in the telemetry database 116 over relatively long time windows and using large enrichment data sets. A batch enrichment framework 134 performs a batch enrichment process, in which events in the telemetry database 116 are further enriched. The timing of the batch enrichment process is driven by an enrichment scheduler 136 which determines a schedule for the batch enrichment process. Note that this batch enrichment is a second stage enrichment, separate from the first stage enrichment that is performed before events are stored in the telemetry database 116.

Enrichment micro services 138 are provided, from which enrichment data can be obtained, both by the batch enrichment framework 134 (second stage enrichment) and the enrichment component 110 (first stage enrichment). These can for example be cloud services which can be queried based on the events to obtain relevant enrichment data. The enrichment data can be obtained by submitting queries to the enrichment micro services based on the content of the events. For example, enrichment data could be obtained by querying based on IP address (e.g. to obtain data about IP addresses known to be malicious), file name (e.g. to obtain data about malicious file names) etc.

In an analytics/detection stage, the collected telemetry events are subject to sophisticated real-time analytics/detections, by an analysis engine 118 (detection engine). This may include the use of statistical analysis techniques commonly known as “machine learning” (ML) and/or as rules-based detection.

The analysis engine 118 is shown having inputs connected to the message queue 106 and the telemetry database 116 for receiving events for analysis. The events received at the analysis engine 118 from the message queue 106 directly are used, in conjunction with the events stored in the telemetry database 116, as a basis for detections within the analysis engine 118. Queued events as received from the message queue 106 permit real-time analysis, whilst the telemetry database 116 provides a record of historical events to allow threats to be assessed over longer time scales as they develop.

Significant detections give rise to “observations”, which may, in turn, be compiled (clustered/combined) into “cases”. Detections may, for example, be based on recognized tactics, techniques and/or other threat/attack patterns or anomalies (such as unsupervised anomaly detection). A pipeline is provided to selectively and intelligently alert an analyst to observations or cases that are deemed to be of sufficient significance.

Observations and cases are stored in a separate ‘experience’ database 124 (which may also be a distributed database). Observations and cases are stored in the same database 124 as each other in the following examples (but separate from the telemetry database 116), and in that context, the terms ‘case database’ and ‘observation database’ are used interchangeably with ‘experience database’. In other implementations cases and observations may be stored in separate case and observation databases.

Observations may be generated based on events that are received at the analysis engine from the message queue 106, in real-time or near-real time. This includes events in the message queue 106 which have been subject to the first stage enrichment (but not yet second stage enrichment).

Observations may also be generated based on events that are stored in the telemetry database 116. For example, it may be that an event is only identified as potentially threat-related (triggering a detection) when that event has been enriched in the second stage enrichment.

An observation is generally generated based on a single event (whether received from the telemetry database 116 or the message queue 106 directly). The single event could be a joint event (meaning that certain short-term correlations may already have been taken into account at the point an observation is generated). Each observation has at least one assigned threat score indicating the significance of the observation. For example, the threat score may denote one or both of confidence and severity (e.g. a high score may indicate a high confidence that an attack of material severity is occurring or has occurred). A threat score may, in that case, increase if the confidence increases, or the severity increases or both. In other implementations, separate confidence and severity scores may be computed and used within the system. Threat scores may be numerical or categorical (e.g. ‘high’, ‘medium’, ‘low’). Observations and/or cases may be selectively escalated to an analyst based on their threat scores, to provide targeted alerts and/or reporting (reducing false positives, overreporting etc.).

Longer-term correlations are accounted for by grouping observations into cases when those observations appear to be related. The grouping of observations into cases considers longer-term temporal correlations between the underlying events. Once created, cases may be developed by matching subsequent observations to existing cases in the case database 124. A case may be assigned a threat score based on its constituent observations. Observations/cases may, for example, be populated with network data, endpoint data or a combination of endpoint and network data (or more generally different forms of telemetry data) obtained from multiple telemetry sources. The following description refers to network and endpoint events, but applies more generally to other forms of structured telemetry received and processed within the system, such as third-party telemetry, cloud telemetry etc.

A case may, for example, be created for at least one defined threat hypothesis, by clustering together observations of different tactics/techniques associated with the threat hypothesis. More generally, an observation may be generated in response to an event that is classed as potentially malicious, and observations may be grouped into cases when it is determined that they might relate to a common threat. Once a case has been created, it may be populated with further observation(s) that are identified as related to the case in question in order to provide a timeline of observations/events that underpin the case.

Note that a detection may be significant enough to result in an observation, but the observation may or may not be significant enough to escalate it to an analyst at that point. Similarly, the analyst will not generally be alerted to every new case. Rather, cases and/or observations may only be reported to an analyst to alert them to a potential threat when their threat scores reach a significance threshold, or meet some other significance condition. Thus, a large number of observations and/or cases may be created in the background to which an analyst is not alerted, because they are not deemed significant enough. As an example, a first observation may be generated which is not deemed significant enough to report. However, when a second observation is subsequently generated, the analysis may indicate a relationship to the first observation, causing those observations to be grouped in a case. In combination, those observations may or may not be significant enough for the case (group of observations) to be reported at that point (e.g. the case may never be reported, or it may only be reported when a further observation(s) has been subsequently added to it).

Each case/observation is assigned at least one threat score, which denotes its significance When the threat score for a case reaches a significance threshold or the case/observation meets some other significance condition, this causes the case to be rendered accessible via a case user interface (UI) 126.

Access to the cases and observations via the case UI 126 is controlled based on the threat scores in the case records in the experience database 124. A user interface controller (not shown) has access to the cases in the experience database 124 and their threat scores, and is configured to render a case accessible via the case UI 126 in response to its threat score reaching an applicable significance threshold.

Such cases can be accessed via the case UI 126 by a human cyber defense analyst. In this example, cases are retrieved from the experience database 124 by submitting query requests via a case API (application programming interface) 128. The case (UI) 126 can for example be a web interface that is accessed remotely via an analyst device 130.

Thus within the analysis engine there are effectively two levels of escalation.

Case and observation creation, driven by individual events or groups of events that are identified as potentially threat-related.

Escalation of cases to the case UI 126, for use by a human analyst, only when their threat scores become significant, which may only happen when a time sequence of interrelated events has been built up over time

As an additional safeguarding measure, the user interface controller may also escalate a series of low-scoring cases related to a particular entity to the case UI 126. This is because a series of low-scoring cases may represent suspicious activity in themselves (e.g. a threat that is evading detection). Accordingly, the platform allows patterns of low-scoring cases that are related by some common entity (e.g. user) to be detected, and escalated to the case UI 126. That is, information about a set of multiple cases is rendered available via the case UI 126, in response to those cases meeting a collective significance condition (indicating that set of cases as a whole is significant).

The event-driven nature of the analysis inherently accommodates different types of threats that develop on different time scales, which can be anything from seconds to months. The ability to handle threats developing on different timescales is further enhanced by the combination of real-time and non-real time processing within the system. The real-time enrichment, joining and providing of queued events from the message queue 106 allows fast-developing threats to be detected sufficiently quickly, whilst the long-term storage of events in the telemetry database 116, together with batch enrichment, provide a basis for non-real time analysis to support this.

The above mechanisms can be used both to match incoming events from the message queue 106 and events stored in the telemetry database 116 (e.g. earlier events, whose relevance only becomes apparent after later event(s) have been received) to cases. Appropriate timers may be used to determine when to look for related events in the telemetry database 116 based on the type of event. Depending on the attacker techniques to which a particular event potentially relates, there will be a limited set of possible related events in the telemetry database 116. These related events may only occur within a particular time window after the original event (threat time window). The platform can use timers based on the original event type to determine when to look for related events. The length of the timer can be determined based on the threat hypothesis associated with the case.

The analysis engine is shown to comprise a machine reasoning framework 120 and a human reasoning framework 122. The machine reasoning framework 120 applies computer-implemented data analysis algorithms to the events in the telemetry database 116, such as ML techniques.

Individual events may be related to other events in various ways but only a subset of these relationships will be meaningful for the purpose of detecting threats. The analysis engine 118 uses structured knowledge about attacker techniques to infer the relationships it should attempt to find for particular event types.

This can involve matching a received event or sets of events to known tactics that are associated with known types of attack (attack techniques). Within the analysis engine 118, a plurality of detection modules (not shown) are provided, each of which queries the events (and possibly other data) to detect suspicious activity. For example, a detection module might be associated with a tactic and technique that describes respective activity it can find. A hypothesis defines a case creation condition as a “triggering event”, which in turn is defined as a specific analytic result or set of analytic results that triggers the creation of an observation. A hypothesis also defines a set of possible subsequent or prior tactics or techniques that may occur proximate in time to the triggering events (and related to the same, or some of the same, infrastructure) and be relevant to proving the hypothesis. Because each hypothesis is expressed as tactics or techniques, there may be many different detection modules that can contribute observations to a case. Tactics are high level attacker objectives like “Credential Access”, whereas techniques are specific technical methods to achieve a tactic. In practice it is likely that many techniques will be associated with each tactic.

For example, it might be that after observing a browser crashing and identifying it as a possible symptom of a “Drive-by Compromise” technique (and creating a case in response), another observation proximate in time indicating the download of an executable file may be recognized as additional evidence symptomatic of “Drive-by Compromise” (and used to build up the case). Drive-by Compromise is one of a number of techniques associated with an initial access tactic.

As another example, an endpoint event may indicate that an external storage device (e.g. USB drive) has been connected to an endpoint and this may be matched to a potential “Hardware Additions” technique associated with the initial access tactic. The analysis engine 118 then monitors for related activity such as network activity that might confirm whether or not this is actually an attack targeting the relevant infrastructure.

One form of analysis can be formulated around an attack framework, such as the “MITRE ATT&CK framework”. The MITRE ATT&CK framework is a set of public documentation and models for cyber adversary behavior. It is designed as a tool for cyber security experts. In the present context, the MITRE framework can be used as a basis for creating and managing cases. In the context of managing existing cases, the MITRE framework can be used to identify patterns of suspect (potentially threat-related behavior), which in turn can be used as a basis for matching events received at the analysis engine 118 to existing cases. In the context of case creation, it can be used as a basis for identifying suspect events, which in turn drives case creation. This analysis is also used as a basis for assigning threat scores to cases and updating the assigned threat scores as the cases are populated with additional data. However, it will be appreciated that these principles can be extended to the use of any structured source of knowledge about attacker techniques. The above examples are based on tactics and associated techniques defined by the Mitre framework. The described techniques are not limited to Mitre, and can be applied with other forms of tactics/techniques, e.g. in alternative (including bespoke) threat models, or tactics/techniques that are learned via supervised or unsupervised machine learning processing (or other pattern recognition or statistical analysis methods). ‘Learned’ tactics or techniques characterize potential attacks in machine-understandable terms, which may or may not be interpretable to a human. Tactics/techniques may for example be learned by training one or more models on existing or synthetic attack data, and/or from data learned in recording human analyst behavior.

In addition to the case UI 126, a “hunting” UI 140 is provided via which the analyst can access recent events from the message queue 106. These can be events which have not yet made it to the telemetry database 116, but which have been subject to first stage enrichment and correlation at the event enhancement system 108. Copies of the events from the message queue 106 are stored in a hunting ground 142, which may be a distributed database, and which can be queried via the hunting UI 140. This can for example be used by an analyst who has been alerted to a potential threat through the creation of a case that is made available via the case UI 126, in order to look for additional events that might be relevant to the potential threat.

In addition, copies of the raw network data itself, as obtained through tapping etc., are also selectively stored in a packet store 150. This is subject to filtering by a packet filter 152, according to suitable packet filtering criteria, where it can be accessed via the analyst device 130. An index 150a is provided to allow a lookup of packet data 150b, according to IP address and timestamps. This allows the analyst to trace back from events in the hunting ground to raw packets that relate to those events, for example.

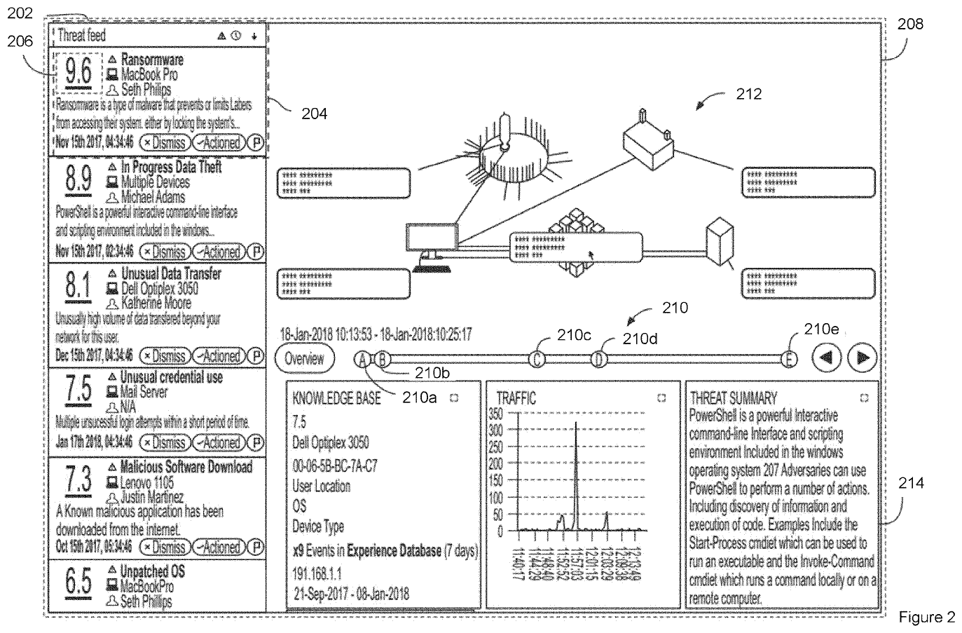

FIG. 2 shows an example of a page rendered by the case UI 126 at the analyst device 130. A list of cases/observations 202 is shown, each of which is selectable to view further details of the case in question. Cases/observations are only displayed in the case list 202 if their respective threats scores have reached the required thresholds. The cases in the case list 202 are shown ordered according to threat score. By way of example, the first case 204 in the case list 202 has a threat score of 9.6 (labeled as element 206). Further details of the currently selected case are shown in a region 208 adjacent to the case list 202. In particular, a timeline 210 of the events on which the case is based is shown. That is, the events with which the case is populated in the experience database 124. In addition, a graphical illustration 212 of network components to which those events relate is shown in association with the timeline 210. This can, for example, include endpoints, infrastructure components, software components and also external components which components of the network are in communication with. Additional information that is relevant to the case is also shown, including a threat summary 214 that provides a natural language summary of the threat to which the case relates. This additional information is provided in the form of “widgets” (separable threat information elements), of which the threat summary 214 is one. A visual (or other alert) may be generated when the threat score reaches a certain threshold. For example, a visual alert may be generated by adding a visual indicator of a case to the case list 202. The timeline 210 comprises selectable elements corresponding to the underlying events, which are labeled 210a to 210e respectively. Selecting these timeline elements causes the accompanying graphical representation 212 to be updated to focus on the corresponding network components. The widgets below the timeline are also updated to show the information that is most relevant to the currently selected timeline element.

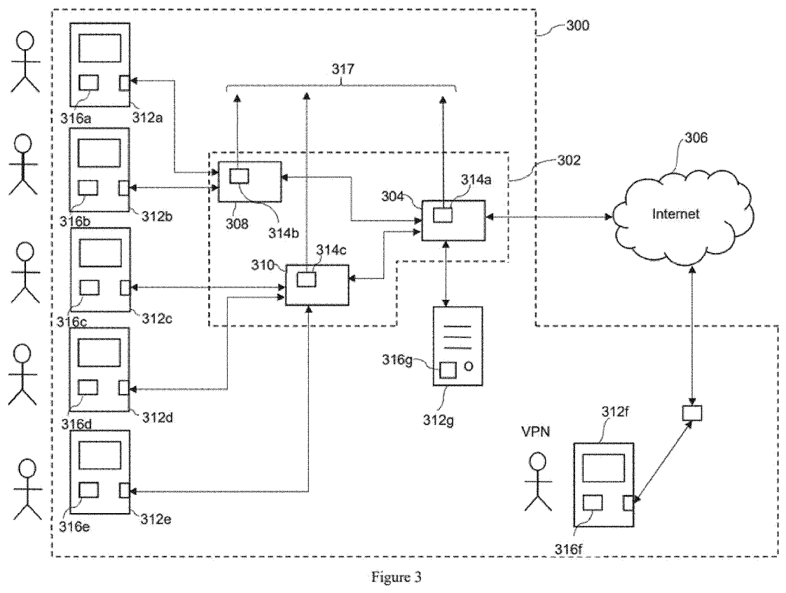

FIG. 3 shows a schematic block diagram of an example network 300 which is subject to monitoring, and which is a private network. The private network 300 is shown to comprise network infrastructure, which can be formed of various network infrastructure components such as routers, switches, hubs etc. In this example, a router 304 is shown via which a connection to a public network 306 is provided such as the Internet, e.g. via a modem (not shown). This provides an entry and exit point into and out of the private network 300, via which network traffic can flow into the private network 300 from the public network 306 and vice versa. Two additional network infrastructure components 308, 310 are shown in this example, which are internal in that they only have connections to the public network 306 via the router 304. However, as will be appreciated, this is purely an example, and, in general, network infrastructure can be formed of any number of components having any suitable topology. In addition, a plurality of endpoint devices 312a-312f are shown, which are endpoints of the private network 300. Five of these endpoints 312a-312e are local endpoints shown directly connected to the network infrastructure 302, whereas endpoint 312f is a remote endpoint that connects remotely to the network infrastructure 302 via the public network 306, using a VPN (virtual private network) connection or the like. It is noted in this respect that the term endpoint in relation to a private network includes both local endpoints and remote endpoints that are permitted access to the private network substantially as if they were a local endpoint. The endpoints 312a-312f are user devices operated by users (client endpoints), but in addition one or more server endpoints can also be provided. By way of example, a server 312g is shown connected to the network infrastructure 302, which can provide any desired service or services within private network 300. Although only one server is shown, any number of server endpoints can be provided in any desired configuration.

For the purposes of collecting raw network data, a plurality of monitoring components 314a-314c are provided. These can for example be network taps. A TAP is a component which provides access to traffic flowing through the network 300 transparently, i.e. without disrupting the flow of network traffic. TAPs are non-obtrusive and generally non-detectable. A TAP can be provided in the form of a dedicated hardware TAP, for example, which is coupled to one or more network infrastructure components to provide access to the raw network data flowing through it. In this example, the taps 314a, 314b and 314c are shown coupled to the network infrastructure component 304, 308 and 310 respectively, such that they are able to provide, in combination, copies 317 of any of the raw network data flowing through the network infrastructure 302 for the purposes of monitoring. It is this raw network data that is processed into structured network events for the purpose of analysis.

For the purpose of collecting endpoint data, respective endpoint agents 316a-316g (corresponding to endpoint agents 316 in FIG. 1) are deployed on the endpoints 312a-312g. Each endpoint agent is implemented in the form of code (software) executed on the endpoint in question. Endpoint monitoring software can be executed on any type of endpoint, including local, remote and/or server endpoints as appropriate. This monitoring by the endpoint agents is the underlying mechanism by which endpoint events are collected within the network 300. Enhanced endpoint agents that additionally implement local network traffic monitoring and reporting (generating pre-joined endpoint and network events ‘at source’) are described later.

Any of the endpoint agents 312a-312f depicted in FIG. 3 could be implemented as an EPNS executed on the respective endpoint 312a-312f, to additionally monitor and report network telemetry at that endpoint, which would reduce the reliance on the monitoring components 314a-314c. For the remote endpoint 312f, an EPNS deployed to that endpoint can render visible its network traffic even when that network traffic is not passing through any of the monitoring components 314a-314c.

FIG. 3A shows a network monitoring system 170 comprising a network TAP 162 that may be deployed with a monitored network. The TAP 162 could for example be installed within a corporate enterprise or otherwise private network, forming part of its network infrastructure. Although only a single TAP 162 is depicted, multiple such TAPs could be deployed across one or multiple private/closed networks. The TAP 172 is invisible to users/devices within the network being monitored. Network traffic passes transparently through the TAP 172, and the TAP 172 generates copies of network packets passing through it (tapped network traffic). The tapped network traffic is provided to a network appliance 174 for processing.

An expanded view shows the appliance 174 to comprise at least one processor 176 (such as a CPU), which is coupled to at least one memory 178 and at least one input-output (I/O) device, such as a network interface. The I/O device 182 enables the processor 176 to receive the tapped network traffic and temporarily store the tapped network traffic in the memory 178 for processing. A set of probe software referred to as an appliance endpoint network sensor (APNS) 180 is shown executed on the processor 176.

The APNS 180 operates in a similar manner to the EPNS 162, insofar as it processes the tapped network data in order to extract a similar level of network traffic metadata (according to the data model 164). However, whereas the EPNS 162 summarizes traffic local to its endpoint, the APNS 180 summarizes the network traffic flowing through the TAP 172. The network monitoring system 170 thus has the ability to receive network traffic and extract network traffic metadata therefrom, whilst still allowing the network traffic to pass transparently through the TAP 172. Although, in this instance, the TAP 172 and appliance 174 are shown as separate components, this core functionality may be provided by any component or components that is/are implemented using any combination of hardware and/or software. The APNS 18—could alternatively be implemented in hardware, or in a combination of hardware and software.

The APNS 180 outputs network telemetry to the message queue 108, which, in addition to being appropriately structured, is also partially enriched via multithreaded in-memory enrichment processing performed at the appliance 174. The APNS enrichment processing is described in detail below.

Messages written to the message queue 106 by the APNS 180 become available for further processing (analysis, further enrichment etc.) within the system of FIG. 1, along with telemetry messages from other sources.

### Multithreaded Enrichment Processing Architecture

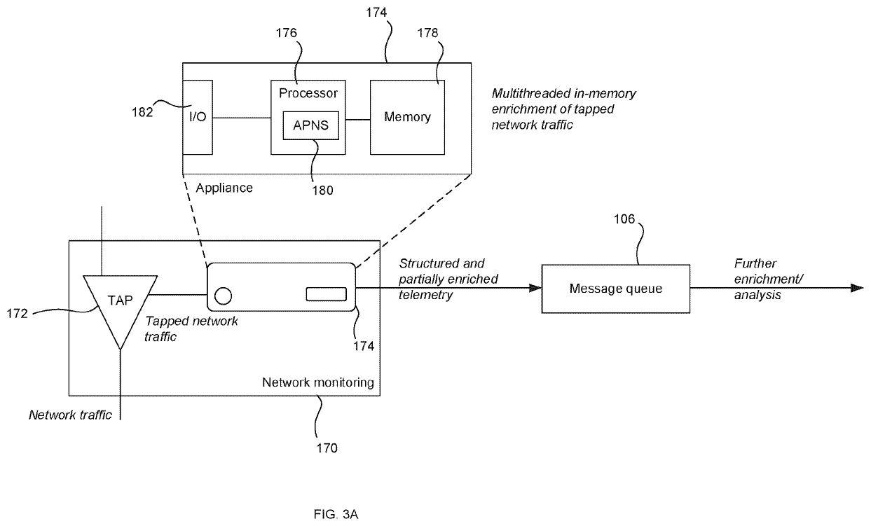

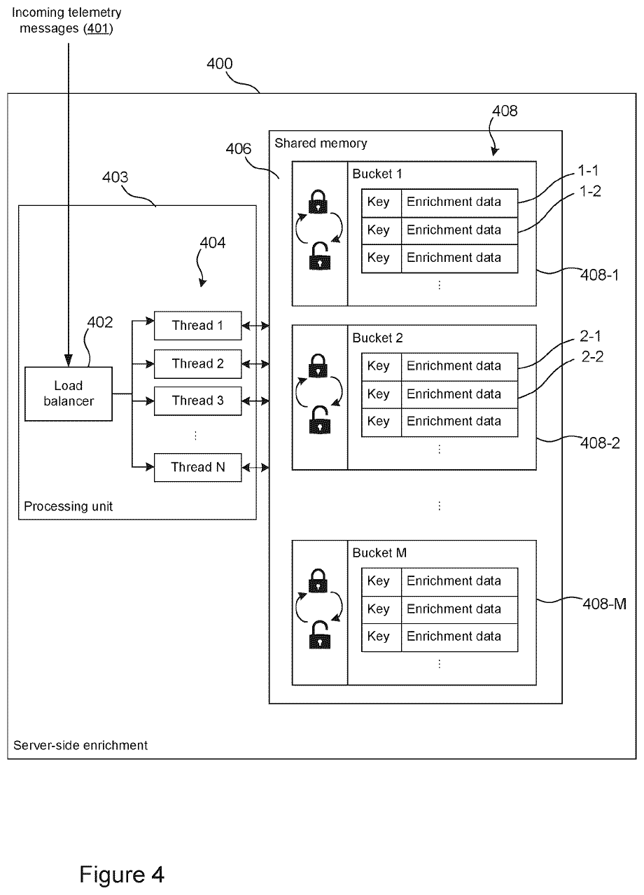

FIG. 4 shows a schematic block diagram of an enrichment processing system 400 having a multithreaded processing architecture.

Incoming telemetry messages 401 are received at a load balancer 402, and distributed amongst multiple processing threads 404 for enrichment processing.

A processing thread refers to a thread of execution running on a processing unit 403, such as a central processing unit (CPU) or a processor core of a multicore processor. Multiple threads can be executed concurrently on the same processing unit as a way to improve utilization of the processing unit's computational resources. Such threads are managed by a scheduler (not shown), typically within the operating system, to provide essentially concurrent execution through context switching (e.g. time slicing). Each thread is implemented, at the hardware level, as a sequence of program instructions executed on the processing unit 403 (or on one of the processing units) that can be managed by the scheduler independently of the other processing thread(s). Code, instructions etc. may be stored as appropriate on transitory or non-transitory media (examples of the latter including solid state, magnetic and optical storage device(s) and the like).

The processing unit 403 is coupled to a memory 406. The memory 406 is referred to as a shared memory, as it comprises at least one memory region that is shared between the processing threads 404.

Whilst FIG. 1 shows the load balancer 402 and the multiple threads 404 executed on a single processing unit 403, alternatively, the multiple threads 404 may be distributed across multiple processing units (e.g. multiple CPUs or processor cores) having access to the shared memory 406 (shared between processing units, and between threads). With multiple processing units, concurrency is provided through a combination of hardware parallelization (distributing threads across the multiple processing units) and multithreading within each processing unit.

One source of enrichment data is the incoming telemetry messages 401 themselves, whereby information is extracted from certain telemetry messages, and used to enrich other telemetry messages. For example, a first telemetry message might comprise or relate to a domain name system (DNS) response that was returned by a DNS server in response to a DNS query, and which maps a server IP address to a DNS query parameter (e.g. a domain name or other DNS-related information) provided in the DNS query. When that same server IP address is observed in a second telemetry message(s), e.g. comprising or relating to a TCP packet exchanged with the server, that other telemetry message can be enriched with the DNS-related information extracted from the query.

The incoming telemetry messages may be ‘raw’ telemetry messages (such as IP packets captured by a TAP or mirror), or raw telemetry may be subject to a degree of processing prior to enrichment. For example, in the platform of FIG. 1, enrichment is applied following re-structuring according to the data model 164 (by the standardization components 104 or the EPNS 162), and in some cases, such records may contain a more concise metadata summary (rather than the full raw telemetry).

Each of the processing threads 404 is responsible for recognizing telemetry messages that contain enrichment data, extracting and storing that enrichment data for subsequent use, and enriching telemetry messages using stored enrichment data. The load balancer 402 is generally agonistic to the content of the telemetry messages, and the primary aim of the load balancer 402 is to evenly distribute the processing across the processing threads. Certain telemetry messages might be related to each other (e.g. a DNS response might be related to a subsequent TCP packet), although the load balancer does not attempt to allocate telemetry messages to threads on this basis. As such, a thread that is tasked with enriching a second telemetry message may require enrichment data that was extracted from a related first telemetry message by a different thread, requiring some form of shared state. Therefore, each processing thread stores extracted enrichment data in the shared memory 406 accessible to each other thread.

Synchronization between threads 404 that share resources is achieved through ‘locks’, whereby any thread can temporarily acquire a lock on a shared resource, preventing any other thread from accessing that shared resource until the lock is released. Read locks and write locks are used in this context.

In the present context, shared resources are provided in the form of M storage ‘buckets’ 408 (Buckets 1 to M). Each storage bucket 408-1, 408-2, . . . , 408-M is a container object that can hold multiple elements. Each bucket can be in a lock state (meaning one of the threads 404 is currently in possession of its lock) or in an unlock state (meaning that any thread is free to acquire its lock). Any thread in possession of the lock has full read/write to the storage bucket. Each storage bucket 408-1, 408-2, . . . , 408-M can be locked and unlocked independently of any other storage bucket.

Elements are stored within each storage bucket 408-1, 408-2, . . . , 408-M as key-value pairs, where ‘m-i’ denotes the ith key value pair in storage bucket m. The value is some item of stored data (such as enrichment data extracted from a telemetry message), identified using the key (used to search for data items within the storage buckets). The key-value pairs may, for example, be contained in a hash table, linked list, or any suitable data structure within the bucket. When a given storage bucket is in a lock state, every element held in that bucket is accessible only to the thread in possession of its lock; no other thread is permitted to access any element in that bucket until the lock is released (but this will not affect the ability of any other thread to access or store elements in any other storage bucket not currently in a lock state). Thus, when Bucket 1 (408-1) is locked, only the thread in possession of the lock on Bucket 1 can access any of the existing elements 1-1, 1-2, . . . contained in that bucket 408-1, and only that thread can add a new storage element to that bucket 408-1; Bucket 2 (408-2) can be locked/unlocked independently of Bucket 1 (and any other bucket), and when locked, only the thread in possession of the Bucket 2 lock can access the elements 2-1, 2-2, . . . in that bucket 408-2 or add a new storage element to that bucket 408-2 etc.

The description above pertains to a full “write” lock that a thread must obtain before it can write to a bucket. Readers of buckets may also acquire a lock, but only a “read” lock. A thread possessing a read lock on a bucket is permitted to read from the bucket, but not write to it. Moreover, any other thread can simultaneously acquire a read lock in order to read from that bucket simultaneously. However, no thread is permitted to obtain a write lock on a bucket whilst any other thread possesses a read lock on the bucket. This means that multiple readers can read the bucket simultaneously while a read lock is held, but a writer cannot (it needs to wait until readers have released their locks). It follows that a bucket may be in one of three states: 1) unlocked (no thread currently possesses a read lock or write lock, implying that any thread is currently free to acquire a read lock or a write lock); 2) write-locked (a single thread currently possesses a write lock, implying that no other thread is currently able to obtain a read lock or a write lock); or 3) read-locked (one or more threads currently possess one or more read locks, implying that any other thread is currently free to obtain a further read lock, but no other thread can presently obtain a write lock).

As indicated above, in one use case, the multi-threaded architecture of FIG. 4 is used to perform real-time enrichment of tapped network telemetry at the APNS 180. This initial enrichment processing is performed in memory in the APNS probe software.

Returning briefly to FIG. 3A, initial enrichment processing of network telemetry is performed in memory at the APNS 180. In this context, the threads 404 are implemented on the appliance processor 176, and are used to implement the APNS enrichment processing. In this context, the load balancer 402 receives an incoming stream of tapped network packets from the TAP 172, and operates to allocate the tapped network packets amongst the processing threads 404. Each thread within the APNS 180 processes network packets allocated to it, in order to extract and store enrichment data, and to generate enriched telemetry messages that are subsequently outputted to the message queue 106 for further processing.

In this context, incoming network packets from the TAP 172 need to be processed in the APNS 174 at the rate they are received, in order to prevent a bottleneck at the APNS 180. If the APNS 180 were to become a bottleneck for even a relatively short period, the network monitoring component 170 would be rendered ineffective. Multithreading allows faster processing of the incoming stream of tapped network packets.

Speed of enrichment processing is also generally important in a cybersecurity context, particularly in respect of time-critical detection functions. As discussed, the machine reasoning framework 120 of FIG. 1 may include one or more components that operate directly on messages in the message queue 106, and which have thus only been subject to the initial APNS enrichment (and possibly the subsequent first stage enrichment performed on the message queue 106, but not the slower batch enrichment performed on telemetry records contained the telemetry database 116). Such components are generally more limited, but can perform detections on shorter time scales. By way of example, reference is made to our co-pending United Kingdom Patent Application Numbers GB2207992.5 and GB2214371.3 (‘LandingNet’ hereafter), each of which is incorporated herein by reference in its entirety. LandingNet is a fast-response signature-based detection application which operates on queued and serialized telemetry messages. When applied to enriched messages, fast enrichment is important to prevent the first stage enrichment introducing unacceptable latency (or, worse, becoming a bottleneck). Delays in enrichment processing may result in delayed cybersecurity detections, with severe outcomes in a worst-case scenario.

In generating enriched telemetry messages, additional processing may be applied to the tapped network data. For example, the network data may be summarized to generate structured telemetry messages containing network metadata, in accordance with the data model 164 at the APNS 180, which are also enriched at the APNS 180.

‘Lock contention’ occurs when two threads require incompatible access to the same shared resource at the same time to complete respective tasks assigned to them, and it is useful to consider the issue of lock contention within the platform architecture of FIG. 1.

In a lock contention scenario, a first of those threads will initially acquire the required form of lock in performing its current task. A second thread will then determine the lock status of the shared resource (said to be ‘contested’) and, on finding it to be locked in a manner that is incompatible with the task it needs to perform, will be unable to complete its current task. This situation can occur when the second thread requires a read lock on the bucket, but can't obtain it because the first thread holds a write lock on the bucket; or when the second thread requires a write lock, but can't obtain it because the first thread currently holds a read or write lock.

In the context of FIG. 3A, a task requiring access to a shared resources typically involves the processing of some raw telemetry message, such as a network packet, e.g. to extract a piece of enrichment data from the telemetry message and store it in the shared resource, or to enrich the telemetry message using an existing piece of enrichment data contained in the shared resource. If one thread requires access to a shared resource in order to complete the processing of a telemetry message, but that shared resource is incompatibly locked, processing of the telemetry message will have to be halted. Depending on the implementation, this might mean paused execution of the thread itself (meaning the thread is not able to perform any other task until it can acquire the lock on the shared resource, but is still consuming resources); or the thread might temporarily pause processing of the telemetry message in favor of some other task the thread is capable of performing in the meantime (which would still result in delayed processing of the telemetry message, and likely sub-optimal resource utilization); or the thread might abandon processing of the telemetry message, e.g. the message may be queued locally at the appliance 174 to be re-allocated by the load balancer 402 to attempt the enrichment processing a later time (resulting in delayed processing, possibly by a different thread, as well as wasted resource utilization by the thread that abandoned the processing). The latter could even result in the abandonment of the enrichment processing of the telemetry message altogether (by any thread), e.g., if a cut-off time window is imposed on the initial appliance enrichment.

In FIG. 4, lock contention can occur when two or more of the threads 404 require access to the same storage bucket simultaneously, and at least one of those threads requires write access. However, as explained below, the storage buckets 404 are constructed and used in a manner that significantly reduce the probability of lock contention occurring in respect of a storage bucket, which in turn improves the functioning of the underlying processing unit 403 (or processing units) through better utilization of its (or their) resources.

To give a concrete enrichment example, an incoming telemetry message may contain a network address (e.g., an IP address) of a server endpoint, and be enriched with additional information about the server endpoint (e.g., an associated domain name).

In this scenario, one option would be to store enrichment data about the server endpoint in association with a network address of the server endpoint, such as its IP address, which in turn would allow telemetry messages involving the server IP address to be enriched with those details. This is seemingly attractive, given its simplicity and conciseness, and is essentially the model used to implement a “reverse DNS lookup”, in which a lookup table contains domain names keyed by server IP address (allowing a server IP address to be resolved to an associated domain name, in contrast to a regular DNS lookup that resolves a domain name to an IP address). In an enrichment context, this same reverse lookup model could, in principle, be used for message enrichment: when observing, say, a TCP message, a reverse lookup could be performed on each IP address in the IP header, to obtain any enrichment data associated with the IP address, using a lookup table keyed by IP address. However, this model presents various challenges in a multithreaded architecture.

If such a lookup table were implemented as a single shared resource, in the worst case, this could effectively destroy all thread concurrency: if access to the shared lookup table were required for a high proportion of telemetry messages, the lookup table would be permanently contested, effectively serializing the threads 404 (one thread would obtain a write lock on the shared resource, and all other threads would have to wait for it to release the lock).

If the system were restricted to the use of essentially ‘static’ enrichment data from some external source, the lookup table could simply be duplicated across all threads, e.g., providing each thread with its own copy of a reverse DNS lookup table that is not a shared resource. However, this would severely restrict the ability of the system to accommodate enrichment data derived from the incoming telemetry itself, particularly on the timescales required. Continuing the DNS example, suppose a client endpoint performs a DNS lookup on a domain name. This would result in a DNS query to a DNS server, and a response from the DNS server. The DNS response is directed to the client IP address, and contains the domain name provided by the client endpoint, and a server IP address associated with the provided domain name. The DNS response is a useful source of enrichment data: a thread observing the DNS response can extract the domain name, and store that information for use in subsequent message enrichment. When a TCP message exchanged between the same client and server endpoints is subsequently observed, in principle that message could be enriched with the details extracted from the DNS response. However, this requires some mechanism to share those details between threads, because there is no guarantee that the TCP message and the DNS response will be processed by the same thread (an alternative option would be to implement the load balancing in a way that does not require shared resources; this would require a more complex load balancing mechanism that allocates messages containing enrichment data and messages benefiting from that enrichment data to the same thread; as well as increasing the load balancing complexity, in the present context, this may also result in an uneven distribution of processing across threads, and thus sub-optimal resource utilization).

Telemetry-derived enrichment data also needs to be shared between threads sufficiently quickly. For example, in the previous example, the time lag between the DNS response and the first TCP message exchanged between the client and the server is typically fractions of a second (e.g. 10s or 100s of milliseconds). Sharing of data between threads on the required timescales can be achieved using shared in-memory resources, but in that case the issue of lock contention has to be addressed.

The use of independent storage containers goes some way to addressing this issue. However, there are various nuances that need to be considered in optimizing the distribution of enrichment data across storage buckets.

Following the ‘reverse lookup’ model, in which domain names are keyed by server IP address, one option would be to simply split the lookup table across buckets. Each bucket would store the lookup table entries for a specified server IP address range (in practice, a hash table could be used, where domains are keyed by server IP address hashes). With N buckets, in principle the probability of lock contention is reduced by a factor of 1/N.

However, this 1/N reduction assumes the probability of any given thread requiring access to any given bucket is roughly the same across all buckets. In practice, that may not be true, as a relatively small number of server IP addresses often account for a disproportionately high volume of network traffic. For example, a popular cloud provider might host infrastructure for a large number of tenants all behind a common IP address, with, some additional information at the transport (e.g. TCP) or application (e.g. HTTP) level used to route incoming requests to the correct infrastructure, resulting in a disproportionately high volume of network telemetry involving the cloud service provide IP address. If telemetry-derived enrichment data were distributed across buckets according to server IP address only, the bucket whose IP address range happens to contain the cloud service provider IP address is likely to see a disproportionately high number of access attempts, and thus a much higher rate of lock contention between threads.

Moreover, in the above scenario, there is an additional nuance around the nature of the enrichment data. Continuing the DNS example, the most basic form of reverse DNS lookup assumes a one-to-one relationship between server IP addresses and domain names/DNS details, whereby a server IP address can be uniquely resolved to a domain name. However, this is not necessarily the case in practice. In the previous example, the cloud service provider IP address might be associated with multiple domain names, and there are other contexts where a single IP address might have multiple associated domain names (distinguished, e.g., at the TCP/transport or HTTP/application level, rather than the IP level). This could be accommodated by storing all known domain names associated with a given server IP address in a reverse DNS lookup table. However, this ignores an important client-specific element: in a cybersecurity context, it is generally more informative to know which of these domains a given client has attempted to access, especially if a given server IP address is associated with a large number of domain names attached to different sets of cloud infrastructure. Hence, a need arises to store server-related but client-specific enrichment data with a given server IP address. For a popular server IP address accessed by many clients, the amount of client-specific data increases, and a mechanism is also needed to ensure this data is distributed reasonably uniformly across storage buckets.

With the above considerations in mind, in the following examples, enrichment is considered in the context of communication between devices. An overarching aim is to accommodate tailored enrichment data that is as specific as possible to each device involved in the communication. Within this framework, the multithreading architecture is designed in a manner that can (i) easily accommodate device-specific enrichment data (such as a client-specific DNS lookup) across multiple threads and (ii) do so in a way that reduces the probability of lock contention between threads.

To this end, pieces of enrichment data (data items) are extracted from telemetry messages in association with respective network address pairs (denoting respective pairs of communicating endpoints). Each piece of enrichment data is treated as unique to that specific endpoint pairing. Enrichment data items are then distributed across the storage buckets 404 based on their network address pairs in a manner that ensures a reasonably even distribution of enrichment data across the storage buckets 404, and thus reduces the probability of lock contention between threads 402 in respect of the shared storage buckets 404, whilst still storing the enrichment data in a logical manner that is straightforward to retrieve as needed.

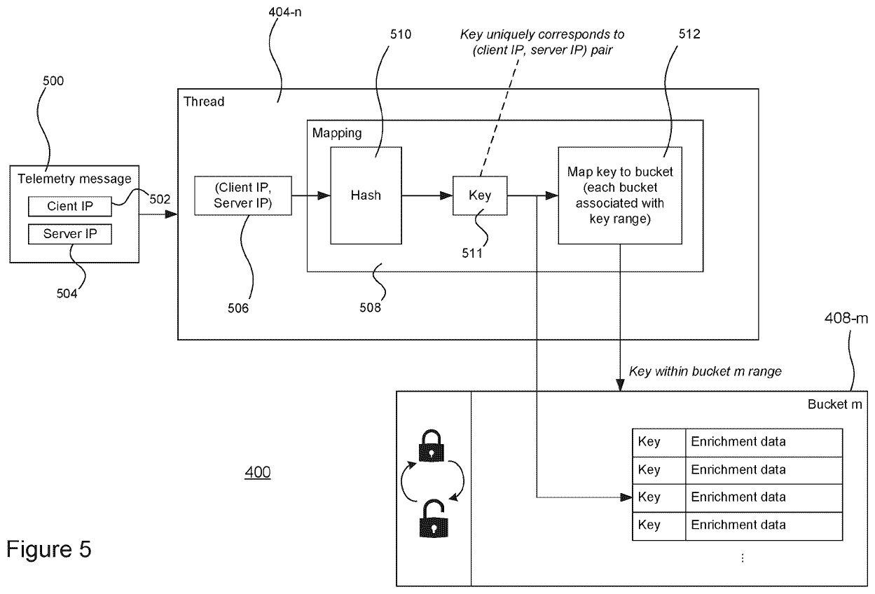

FIG. 5 shows a schematic block diagram of an example processing thread 404-n. The description of the processing thread 404-n applies to each of the multiple processing threads 404 depicted in FIG. 4.

A telemetry message 500 allocated to the thread 404-n is shown to comprise a client IP address 502 and a server IP address 504. The telemetry message 500 may be a message containing enrichment data (that is, data that can be used to enrich other telemetry message(s)) or a message to be enriched with existing enrichment data. It is possible that a telemetry message may contain enrichment data and also be enriched with additional data from a further telemetry message.

The client and server IP address 502, 504 are extracted from the message and used to formulate an address pair 506 comprising the client IP address 502 and the server IP address 504. The address pair 406 is used as a key to store or access enrichment data in the shared memory 406 (not shown in FIG. 5).

The thread 404-n implements a predetermined mapping component 408, which embodies a predetermined mapping function. The mapping component 408 is a functional component, implemented as a subset of the program instructions of the thread 404-n. The mapping component 408 maps the address pair 506 to a corresponding storage bucket 408-m, which can be any of the storage buckets 408 shown in FIG. 4. Enrichment data associated with this address pair 506 is, in turn, stored in the corresponding storage bucket 408-m, in association with the address pair 506. Note, it is the client-server IP address pairing that is used to select the corresponding storage bucket 408-m, and to key the enrichment data in a client-specific manner.

In the depicted example, hash keys are used for greater efficiency. A hash function 510 is applied to the address pair 506 resulting in a hash key 511. A hash key can take a range of possible values, and each of the storage buckets 408 is associated with a predefined subrange (or other subset) of the possible hash values. Having computed the hash key 511 from the address pair 505, a bucket selector 512 of the mapping function 512 identifies the corresponding storage bucket 408-m whose subrange contains the hash key 511. Enrichment data associated with the address pair 506 is stored in the corresponding storage bucket 408-m, in association with the hash key 511 derived from the address pair 506. Whenever that same address pair 506 is observed in a message to be enriched, a matching hash key is derived in the same way, and used to determine and search the corresponding storage bucket 408-m highly efficiently.

In forming the address pair 506, the client and server IP addresses 502, 504 may be ordered according to some predetermined rule, to ensure the same ordering, and thus the same hash key 511, whenever those two addresses are observed together.

The hash function 510 is chosen to provide a good balance between efficiency and collisions. A ‘collision’ occurs when the hash function 510 returns the same hash key for two different inputs (that is, different address pairs). With a collision-free hash function, the probability of a collision is vanishingly small, guaranteeing a unique hash key for any given address pair. In this case, it is sufficient to store only the hash key 511 and the enrichment data in the storage bucket 408-m. However, collision-free hash functions are relatively expensive to compute. For greater efficiency, a weaker form of hash function may be used (e.g. FNV-1a), that has a reasonably low collision rate, but is not guaranteed to be collision free. In that case, enrichment data items associated with different address pairs may occasionally be keyed by the same hash value. This can be resolved, e.g. by storing the (un-hashed) address pair 506 together with the enrichment data (e.g. in a linked list or other data structure keyed by the hash value). When the storage bucket is searched by hash key, on locating a matching hash key (or keys), an additional check is performed on the stored address pair (or pairs) to account for the possibility of a collision. Provided the collision rate is reasonably low, this will have a negligible performance impact.

The use of address pairs to key enrichment data across the storage buckets 504 is well-suited for storing tailored enrichment data, specific to a communication context between two devices (endpoints). Moreover, it provides a higher level of entropy when allocating enrichment data items to storage buckets, ensuring a more even distribution of enrichment data across the storage buckets 404. For example, with a popular server IP address accessed by multiple clients, the client IP addresses will be used in determining where to store the enrichment data. Different IP address pairs, with the same server IP addresses but different client IP addresses, will return different hash keys, and will not necessarily be mapped to the same storage bucket. In this particular context, the main source of entropy is the client IP address, and a more even distribution of data is achieved by using the client IP address in determining where to store (client-specific) enrichment data pertaining to the popular server IP address.

### Dns-Enrichment Use Case

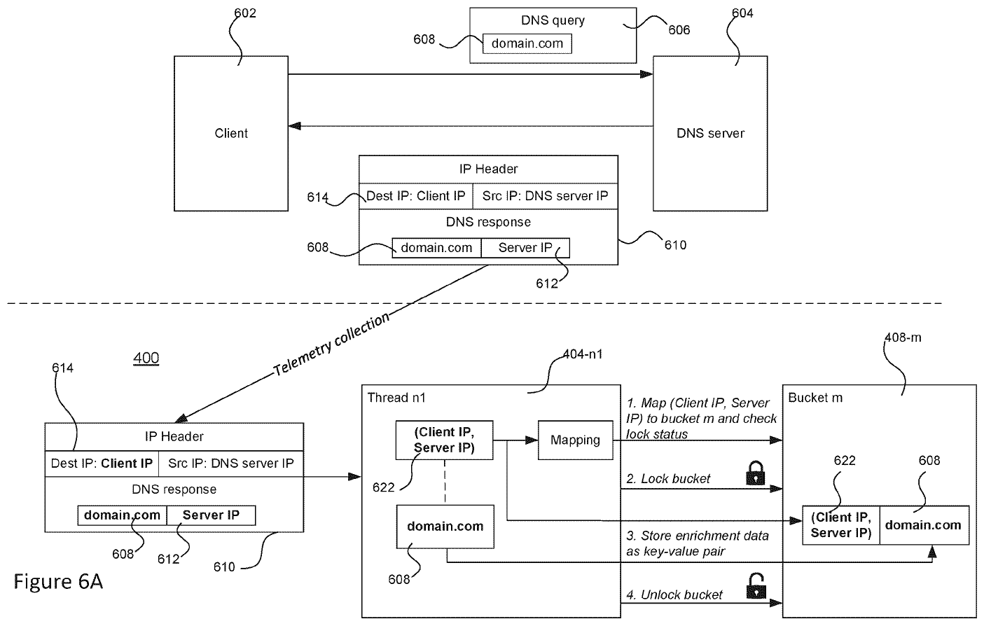

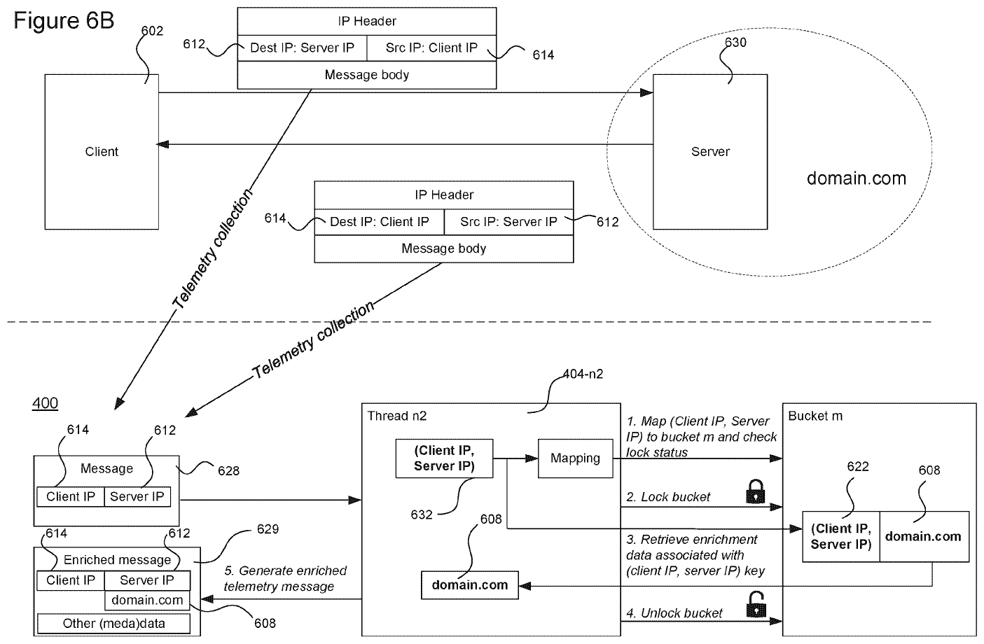

FIGS. 6A and 6B illustrate a particular DNS-enrichment use case.

FIG. 6A shows (top part) a DNS query-response exchange between a client endpoint 602 and a DNS lookup server 604. The client endpoint submits a DNS query 606 containing at least one query parameter, which is a domain name 608 in this example, but more generally can be any DNS query parameter or combination of parameters. The following description refers to the domain name 608, but applies equally to any query parameter or parameter combination. Although not depicted, the DNS query 608 would also contain a client IP address of the client endpoint 602 in a source address field of its IP header, allowing the client endpoint 602 to be identified.

In response to the DNS query 606, the DNS server returns a DNS response 610, containing the domain name 608 provided by the client 602, together with a server IP address 612 associated with the domain name 608. The domain name 608 and server IP address 612 are contained in respective fields within a body of the DNS response 610. In addition, the client IP address, denoted by reference sign 614, is contained in a destination field of the IP header of the DNS response 610 (the IP header will also contain the DNS server IP address in its source field, but this is not used for enrichment purposes in the present example).

As some later time (bottom part of FIG. 6A), the DNS response 610 is observed at the enrichment processing system 400, and allocated to a first processing thread 404-n1 (Thread n1). As noted, the enrichment processing system 400 does not necessarily receive a copy of the DNS response 610 in its original ‘raw’ form; Thread n1 may instead receive a telemetry message in the form of, e.g., a more structured and concise summary of the DNS response 610 (and the ‘observed’ terminology used herein encompasses this scenario). Note that, in a real-time deployment, ‘some time later’ could be, e.g., of the order of seconds, or even tens or hundreds of milliseconds.

Thread n1 recognizes the message as a DNS response, and thus proceeds as follows.

Thread n1 extracts the domain name 608 from DNS response 610, together with the client IP address 614 from the destination field of the IP header and the server IP address 612 from the relevant field within the body of the DNS response, thus forming a first address pair 622 comprising the client IP address 614 and the server IP address 612. The mapping function applied to the first address pair 622 is, in turn, used to select a corresponding storage bucket 408-m in the manner described above with reference to FIG. 5. The details are not duplicated in FIG. 6A, but this would involve the same process of computing a hash key from the address pair 622, and selecting the storage bucket 508-m (Bucket m) whose subrange contains that hash key. The processing then proceeds as depicted in FIG. 6A:
1. The first client-server address pair 622 is mapped to Bucket m, and the lock status of Bucket m is checked; if locked (by another thread(s) holding a write lock or read lock(s)), the processing of the DNS response 610 is halted (see above discussion for details), otherwise:
2. Thread n1 acquires a write lock on the Bucket m, temporarily preventing read or write access to Bucket m by any other thread.
3. Whilst Bucket M is locked to Thread n1, Thread n1 stores the domain name 608 extracted from the DNS response 610 in association with the client-server address pair 622 (although not depicted in FIG. 6A, this is keyed by the hash value computed from the first address pair 622, as in FIG. 5).
4. Once complete, Thread n1 releases the lock on Bucket m, permitting access by any other thread.

Each storage bucket will typically contain multiple enrichment data items, for different address pairs within its associated range. Bucket M might be locked at Step 1 by any other thread accessing or storing any enrichment data item in that bucket.

Memory use is the main tradeoff in determining the total number of buckets N. If N is very large, the probability of low prob of lock contention is very low. However, assuming some amount of memory is pre-allocated to each bucket, then the memory requirements increase with the number of buckets. Memory pre-allocation provides significant performance benefits. It is generally desirable to pre-allocate memory to the greatest extent possible, in order to avoid allocations in performance-sensitive code. So, for example, a hash table or other data structure within a bucket that maps keys to enrichment data might be pre-allocated to some size M, in which case so memory use increases with the number of buckets N as N*M.

FIG. 6B (top part) shows a subsequent message exchange between the client endpoint 602 and a server endpoint 630 having the server IP address 612. This is the same client endpoint 602 as FIG. 6A, and the server 630 associated with the domain 608 whose IP address was returned by the DNS server (604, FIG. 6A).

Messages exchanges between the client endpoint 602 and the server endpoint 630, such as TCP messages, will contain, in their IP headers, both the client IP address 614 and the server IP address 612. The latter will be contained in the destination field and the former in the source field for messages sent from the client 602 to the server 630, and vice versa for messages from the server 630 to the client 602.

FIG. 6B (bottom part) shows one such TCP message 628 which has been observed at the enrichment processing system 400, and allocated to a second thread 404-n2 (Thread n2). Again, it may be that Thread n2 actually receives a telemetry message in the form of a more concise, structured summary of the original message 628. Thread n2 happens to be different from Thread n1 which processed the corresponding DNS request 610 in FIG. 6A, but the processing would be exactly the same if the message 628 happened to be allocated to the same thread.

Thread n2 recognizes the telemetry message as a TCP message to be enriched, causing it to process the message 628 as follows.

Thread n2 extracts the client IP and server IP addresses 614, 612 from the IP header of the message 628, forming a second address pair 632 comprising the client IP address 614 and the server IP address 612. As discussed, a predetermined rule may be used to order the client and server IP addresses 614, 612, so that the second address pair 632 is guaranteed to match the first address pair 622 in FIG. 6A (resulting in the same hash key irrespective of whether the client IP address is in the source field and the server IP address is in the destination field, or vice versa). The processing then proceeds as follows:
1. The second client-server address pair 622 matches the first client-server address pair 622, and is therefore also mapped to Bucket m; the lock status of Bucket m is checked; if write-locked to another thread (another thread holds a write lock), the processing of the TCP message 628 is halted (see above discussion for details), otherwise, if the bucket is unlocked or is only read-locked (one or more other threads hold one or more read locks):
2. Thread n2 acquires a read lock on the Bucket m, temporarily preventing write access to Bucket m by any other thread.
3. Whilst Bucket M is locked to Thread n2, Thread n2 retrieves the domain name 608 stored in Bucket m, as previously extracted from the DNS response 610, by matching the second address pair 632 with the first address pair 622 associated with the stored domain name 608 (keyed by hash value).
4. Once complete, Thread n2 releases the lock on Bucket m, permitting read or write access by any other thread.
5. Thread n2 generates an enriched telemetry message 629 comprising the client IP address 614, the server IP address 612 and the domain name 608, together with any other relevant data (or metadata) contained in (or relating to) the original message 628.

The enriched telemetry message 629 may be essentially a straight copy of the original message 628, but for the addition of the domain name 608, or further processing (e.g. restructuring, metadata extraction etc.) may be applied to the original message 628 in generating the enriched telemetry message 614.

Whilst a TCP message 628 is considered by way of example, the same methodology can be applied to any transport protocol (e.g., UDP).

Note, the processing of FIG. 6A addresses the issue of multiple domain names attached to a single IP address. The domain name 608 stored against the client-server address pair 622 originates from the client's original DNS query 606, i.e. it is the domain name actually queried by the client endpoint 602 (and returned back to the client 602 by the DNS server 604). Although it is a domain name attached to the server IP address 612, it is also client-specific in this sense. Thus, when the later message 628 is subsequently enriched in FIG. 6B, it is enriched specifically with the domain name 108 originally queried by the client, and that client-specific knowledge is generally much more informative in a subsequent detection/analysis.

A second client endpoint might perform a query on a second domain name attached to the same server IP address, and receive the same server IP address back in a DNS response directed to the other client. Within the system, this will be treated as a separate communication context (as it involves a different address pair), and subsequent messages involving the second client and the same server will be enriched with the second domain name that was queried by the second client.

In theory, the same client could query two domain names that happen to be attached to the same server IP, in a relatively short space of time. If the communication were using earlier versions of TLS, for example, disambiguation may be possible using a server name contained within the traffic in plaintext. Otherwise, it may only be possible to use time and sequencing to associate a DNS response with a subsequent TCP or DNS flow, which might occasionally result in multiple domain names being attached to a server IP address in respect of a given client IP address, which in turn can be accounted for in subsequent processing.

An expiration time window may be attached to a piece of enrichment data held in the shared memory, with the enrichment data being removed once it has expired. This prevents messages from being enriched with ‘stale’ enrichment data.

Whilst the above examples consider a cybersecurity application, there are various other contexts that benefit from client-specific passive DNS enrichment. Whilst DNS enrichment is referred to by way of example, the described techniques can be used in any enrichment context, where two different keys are associated with the enrichment information to provide multiple levels of accuracy.

1. A computer system for generating enriched telemetry data, the computer system comprising:
one or more processors configured to implement multiple processing threads; and
a shared memory accessible to each processing thread of the multiple processing threads, and embodying a plurality of storage buckets, each storage bucket lockable by any processing thread to temporarily restrict access by any other processing thread; and
wherein the one or more processors further implement a load balancer configured to receive incoming telemetry messages, and allocate the incoming telemetry messages amongst the multiple processing threads;
wherein the multiple processing threads are configured to perform concurrent processing of the incoming telemetry messages, including:
at a first processing thread: extracting from a first telemetry message a piece of enrichment data and a first network address pair associated therewith, selecting a storage bucket of the multiple storage buckets using a predetermined mapping function applied to the first network address pair, locking the storage bucket to prevent access by any other processing thread, storing the piece of enrichment data in the storage bucket in association with the first network address pair, and unlocking the storage bucket to enable access by any other processing thread; and
at a second processing thread: extracting from a second telemetry message a second network address pair that matches the first network address pair, identifying said storage bucket using the predetermined mapping function applied to the second network address pair, determining whether the storage bucket is currently locked, and (i) if so, halting processing of the second telemetry message, and (ii) if not, locking the storage bucket, retrieving the piece of enrichment data from the storage bucket by matching the second network address pair with the first network address pair, unlocking the storage bucket, and generating based on the second telemetry message an enriched telemetry message containing the piece of enrichment data.

2. The computer system of claim 1, wherein the first telemetry message is or pertains to a response generated by a lookup server, and comprises:
a first network address of a first endpoint,
a query parameter submitted by the first endpoint, and
a second network address of a second endpoint, as returned by the lookup server based on the query parameter;
wherein the first network address pair comprises the first network address and the second network address, and wherein the piece of enrichment data extracted from the first telemetry message comprises the query parameter.

3. The computer system of claim 2, wherein the query response is a domain name system (DNS) response, wherein the first network address is a destination internet protocol (IP) address of the DNS response, and wherein the second network address and the query parameter are contained in a body of the query response, the query parameter being a domain name and the second network address being a second IP address associated with the domain name.

4. The computer system of claim 3, wherein the second telemetry message is or pertains to an exchanged message between the first endpoint and the second endpoint, wherein the second address pair comprises a source address of the exchanged message and a destination address of the exchanged message.

5. The computer system of claim 4, wherein the source address is a source IP address and the destination address is a destination IP address.

6. The computer system of claim 1, wherein the concurrent processing further comprises:
receiving a third telemetry message,
extracting a third network address pair from the third telemetry message, and
identifying a different storage bucket not containing said piece of enrichment data using the predetermined mapping function applied to the third network address pair, wherein the third network address pair has only a single address component in common with the first network address pair associated with the piece of enrichment data.

7. The computer system of claim 1, wherein the one or more processors are further configured to implement:
a detector configured to receive the enriched telemetry message, detect a potential cybersecurity threat using the enrichment data contained in the enriched telemetry message, and generate a cybersecurity alert responsive to detecting the potential cybersecurity threat.

8. The computer system of claim 7, wherein the cybersecurity alert is displayed at a user interface associated with the computer system.

9. The computer system of claim 7, wherein the one or more processors are further configured to implement:
a remediation component configured to receive the cybersecurity alert, and perform a cybersecurity remediation action in response.

10. The computer system of claim 1, wherein the first network address pair comprises a client network address and a server network address, wherein the piece of enrichment data pertains to the server network address, and the predetermined mapping function uses at least the client network address of the network address pair to select the storage bucket.

11. The computer system of claim 10, wherein the predetermined mapping function uses both the client network address and the server network address to select the storage bucket.

12. The computer system of claim 1, wherein, if it is determined the storage bucket is currently unlocked, the second thread pauses processing of the second telemetry message at the second processing thread until the storage bucket is unlocked.

13. The computer system of claim 1, wherein the first processing thread determines whether any other processing thread currently possesses a read lock or a write lock on the storage bucket, and if not, obtains a write lock on the storage bucket to prevent any other thread from obtaining a read lock or a write lock on the storage bucket; and
wherein the second processing thread determines whether any other processing thread currently possesses a write lock on the storage bucket and, if not, obtains a read lock which prevents any other processing thread from obtaining a write lock on the storage bucket but not from obtaining a further read lock on the storage bucket.

14. The computer system of claim 1, wherein each storage bucket has allocated thereto a predetermined amount of memory.

15. The computer system of claim 1, wherein the one or more processors are further configured to implement:
a network monitoring component configured to collect network traffic and provide a stream of telemetry messages as network packets to the load balancer, the first telemetry message corresponding to a first network packet and the second telemetry message corresponding to a second network packet.

16. The computer system of claim 15, wherein the network monitoring component is a network TAP.

17. The computer system of claim 15, wherein the enriched telemetry message contains the enrichment data and a piece of network metadata extracted from the second network packet.

18. A method of generating enriched telemetry data in a multithreaded processor, the method comprising:
receiving, at a load balancer, incoming telemetry messages;
allocating the incoming telemetry messages amongst multiple processing threads, the multiple processing each having access to a shared memory embodying a plurality of storage buckets, each storage bucket lockable by any processing thread to temporarily restrict access by any other processing thread; and
performing, by the multiple processing threads, concurrent processing of the incoming telemetry messages, including:
at a first processing thread: extracting from a first telemetry message a piece of enrichment data and a first network address pair associated therewith, selecting a storage bucket of the multiple storage buckets using a predetermined mapping function applied to the first network address pair, locking the storage bucket to prevent access by any other processing thread, storing the piece of enrichment data in the storage bucket in association with the first network address pair, and unlocking the storage bucket to enable access by any other processing thread, and
at a second processing thread: extracting from a second telemetry message a second network address pair that matches the first network address pair, identifying said storage bucket using the predetermined mapping function applied to the second network address pair, determining whether the storage bucket is currently locked, and (i) if so, halting processing of the second telemetry message, and (ii) if not, locking the storage bucket, retrieving the piece of enrichment data from the storage bucket by matching the second network address pair with the first network address pair, unlocking the storage bucket, and generating based on the second telemetry message an enriched telemetry message containing the piece of enrichment data.

19. One or more non-transitory computer-readable media comprising computer-executable instructions that, when executed by a system comprising a multithreaded processor, implement operations comprising:
receiving, at a load balancer, incoming telemetry messages;
allocating the incoming telemetry messages amongst multiple processing threads, the multiple processing each having access to a shared memory embodying a plurality of storage buckets, each storage bucket lockable by any processing thread to temporarily restrict access by any other processing thread; and
performing, by the multiple processing threads, concurrent processing of the incoming telemetry messages, including:
at a first processing thread: extracting from a first telemetry message a piece of enrichment data and a first network address pair associated therewith, selecting a storage bucket of the multiple storage buckets using a predetermined mapping function applied to the first network address pair, locking the storage bucket to prevent access by any other processing thread, storing the piece of enrichment data in the storage bucket in association with the first network address pair, and unlocking the storage bucket to enable access by any other processing thread, and
at a second processing thread: extracting from a second telemetry message a second network address pair that matches the first network address pair, identifying said storage bucket using the predetermined mapping function applied to the second network address pair, determining whether the storage bucket is currently locked, and (i) if so, halting processing of the second telemetry message, and (ii) if not, locking the storage bucket, retrieving the piece of enrichment data from the storage bucket by matching the second network address pair with the first network address pair, unlocking the storage bucket, and generating based on the second telemetry message an enriched telemetry message containing the piece of enrichment data.
